(19) United States
(12) Patent Application Publication
(10) Pub. No.: US 2005/0274082 A1
(43) Pub. Date: Dec. 15, 2005

(54) Securing clip for gutter cover

(76) Inventor: Bruce L. Welty, Fankfort, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/080,275

(22) Filed: Mar. 15, 2005

Related U.S. Application Data
(63) Continuation-in-part of application No. 10/865,226, filed on Jun. 10, 2004.

(51) Int. Cl. E04D 13/00; E04H 12/34; B66C 23/06; B66C 23/62

(52) U.S. Cl. 52/120

(57) ABSTRACT

A cover for a roof gutter includes a unitary cover panel received by a plurality of securing clips that are attached to a portion of the roof gutter. The unitary cover panel includes a curved front lip positioned adjacent the roof gutter and an opposite roof-side edge to fit beneath shingles of the roof. The unitary cover panel includes four rows of oblong water siphon slots that are positioned between the roof-side edge and the curved lip. Each water siphon slot includes an opening for water to flow through into the gutter and a depending lip formed to extend below a gutter-facing lower surface of the unitary cover panel wherein the depending lip has a convex upper surface to direct water into the gutter.

### REFERENCE TO RELATED APPLICATION

The present application is a continuation-in-part patent application of U.S. patent application Ser. No. 10/865,226, filed Jun. 10, 2004 entitled “Gutter Cover and Fabrication Tooling” which is hereby incorporated by reference in its entirety.

### BACKGROUND OF THE INVENTION

The present invention relates in general to covers for rain-collecting roof gutters, or what are sometimes described as gutter “guards”. Typically, such covers are designed to fit over a portion or all of the gutter upper opening for the purpose of preventing leaves, seeds and related debris from entering the gutter. Some of the earlier gutter cover designs include a curved lower front lip that is positioned in close proximity to the front edge of the gutter. The intent of this curved lip is to route water into the gutter but cause debris to cascade off onto the ground.

More specifically, the present invention relates to the design of water siphon slots that are formed in the upper surface of the gutter cover. These siphon slots are designed to siphon off some portion of the water that is flowing downwardly across the upper surface of the gutter cover. By siphoning off some portion of the water upstream from the lower front edge of the cover, the total volume of water to be handled by the lower front edge of the cover (i.e., the curved front lip) is reduced. Since the siphoning off of water by way of the water siphon slots is due in part to maintaining surface tension contact between the depending lip of each siphon slot and the water, the precise geometry of each water siphon slot becomes important. While there are prior attachable gutter (guard) cover designs with slots, they do not have the requisite geometry for efficiently siphoning off water. Having the desired efficiency is critical for higher water volume conditions.

In one embodiment of the present invention, a C-shaped clip is used for connecting the gutter cover to the gutter. The use of this C-clip permits use of the gutter cover without any connection or fastening of the cover directly to the roof or fascia boards. The C-clip also permits orienting the cover at virtually any angle of incline so as to correspond to the roof pitch. These features are not found in any prior art devices.

In another embodiment of the present invention, a “nose-over” clip is used to secure the gutter cover. The disclosed construction enables the gutter cover to be secured in position and removed without having to remove the clips and without having to use any tools.

A related part of the present invention is the fabrication tooling used to create the unique geometry for each of the water siphon slots. The particular manner or method of use of this fabrication tooling is also important to understand due to design issues that were introduced. This fabrication tooling is designed so as to not only create and shape each slot, but to also create the pattern of slots in the length of material that is used for the gutter cover panel of the present invention. The pattern of slots is important so that the maximum amount of water can be siphoned off, without making the slots large enough to accept any noticeable debris. While some small particles of debris may pass through a slot into the gutter, these small particles are not of sufficient size to create any clogging or plugging issues with either the gutter or the downspout. It is important that nothing pass into the gutter that would be large enough to accumulate in the gutter and/or block the downspout. Sufficient spacing of the siphon slots in a side-to-side direction and in a top-to-bottom direction is important so that the cover is not weakened by being perforated with too many siphon slots. There is a balance to be struck between the number of slots, the amount of water to be siphoned off, and the overall strength of the cover panel. The desired balance is achieved by the present invention.

### SUMMARY OF THE INVENTION

A unitary cover panel for a roof gutter according to one embodiment of the present invention comprises an elongated main body having an upper surface and an opposite gutter-facing surface and being bounded by a longitudinal roof-side edge and opposite thereto a longitudinal gutter-side edge, the main body defining a plurality of water siphon slots that are positioned between the roof-side edge and the gutter-side edge, each water siphon slot including an opening extending through the main body and a depending lip formed to extend below the gutter-facing surface, the depending lip having a convex upper surface so as to facilitate the routing of water through the corresponding siphon slot with the help of surface tension.

One object of the present invention is to provide an improved cover panel for a roof gutter.

Related objects and advantages of the present invention will be apparent from the following description.

### BRIEF DESCRIPTION OF THE DRAWINGS

FIG. 1 is a side elevational view, in full section, of a gutter cover according to a typical embodiment of the present invention.

FIG. 2 is a partial perspective view of a cover panel comprising one portion of the FIG. 1 gutter cover.

FIG. 3 is a side elevational view, in full section, of one water siphon slot that is formed as part of the FIG. 2 cover panel.

FIG. 4 is a fragmentary, side elevational view of a C-clip comprising one portion of the FIG. 1 gutter cover.

FIG. 5 is a side elevational view, in full section, of a gutter cover according to another embodiment of the present invention.

FIG. 6 is a partial, top plan view of the FIG. 5 gutter cover

FIG. 7 is a side elevational view, in full section, of a water siphon slot comprising a portion of the FIG. 6 gutter cover.

FIG. 8 is a diagrammatic, partial, front elevational view of an existing male roller and female roller combination for perforating a panel of metal.

FIG. 9 is a diagrammatic, partial, front elevational view of a male roller according to a typical embodiment of the present invention.

FIG. 10 is a diagrammatic, partial, top plan view of two FIG. 9 male rollers arranged in opposite directions on a common shaft according to the present invention.

FIG. 11 is a partial, perspective view of a first tooling attachment used to fabricate a curved lip portion of the FIG. 2 cover panel.

FIG. 12 is a partial, perspective view of a second tooling attachment used for the fabrication of the curved lip portion of the FIG. 2 cover panel.

FIG. 13 is a partial, perspective view of a third tooling attachment used for fabricating the curved lip portion of the FIG. 2 cover panel.

FIG. 14 is a side elevational view of an alternative clip according to the present invention.

FIG. 15 is a side elevational view, in partial section, showing the attachment of the FIG. 14 clip to a gutter with a gutter cover panel assembled.

FIG. 16 is a front elevational view of the FIG. 15 assembly showing the FIG. 14 clip in a first orientation.

FIG. 17 is a front elevational view of the FIG. 15 assembly with the FIG. 14 clip formed into a securing position.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

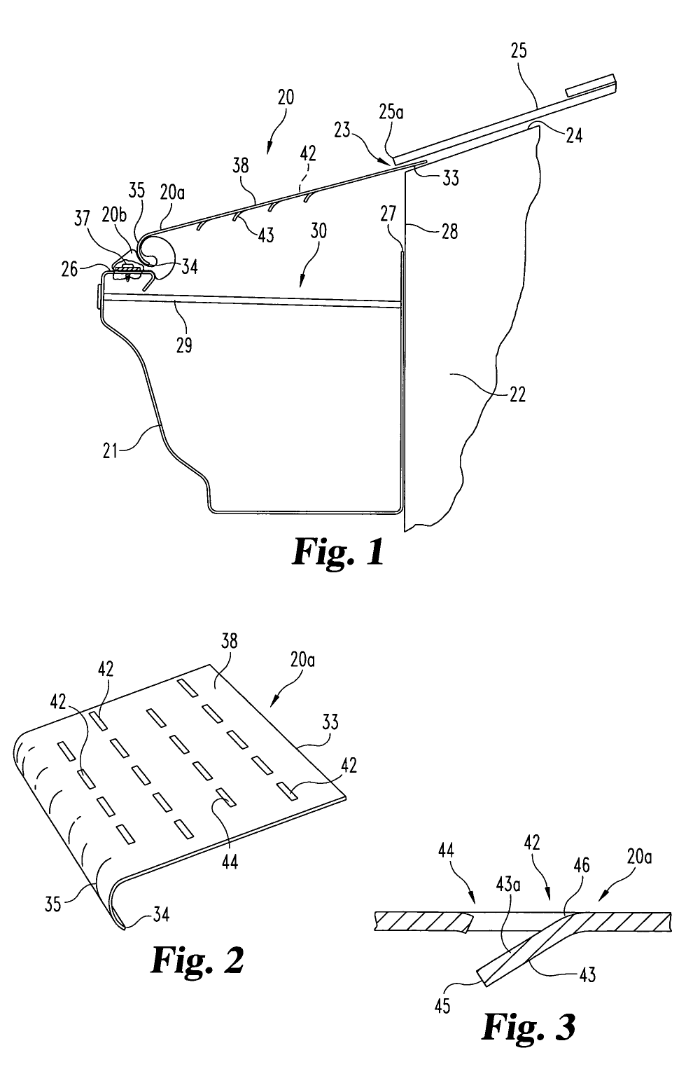

Referring to FIGS. 1-4, there is illustrated a gutter cover 20 that is constructed and arranged according to the present invention. Gutter cover 20 includes a cover panel 20a and at least one C-shaped clip 20b. Each C-clip 20b is securely attached to a rain-collecting roof gutter 21 that is attached to the corresponding structure 22 adjacent the lower edge 23 of the roof 24. The cover panel 20a is received by one or more C-clips 20b, depending on the cover length, and fits beneath the lowermost row of roof shingles.

For the purpose of describing the gutter cover 20, its attachment and its method of use, a conventional residential structure 22 has been selected with a typical roof construction including covering shingles 25. Gutter 21 has an outer, upper edge 26 and an inner, upper edge 27 that abuts up against the fascia board 28. A plurality of gutter screws 29 are used to securely attach the gutter 21 to the fascia board 28 of the structure 22. The upper opening 30 of gutter 21 is wide enough, in a front-to-rear direction, to accept larger debris that can clog the gutter and the associated downspouts. This is why there is value in providing some type of gutter cover, such as that of the present invention, so that such larger debris is prevented from entering gutter 21.

The gutter cover panel 20a is an elongated metal panel that includes an upper, roof edge 33 and an opposite, lower, gutter edge 34. As would typically be the case with regard to gutters and gutter cover panels, the panel includes an elongated main body whose overall length runs substantially parallel to the length of the gutter with a width dimension extending between the roof-side edge 33 and the gutter-side edge 34 that is substantially smaller than the length dimension of the main body.

As will be described in greater detail herein, edge 34 is formed so as to extend below the lower surface of the cover panel or what would be understood as the gutter-facing surface and this forming operation with regard to edge 34 creates a rounded lip 35 that is positioned above and in close proximity to the outer, upper edge 26 of gutter 21. While various construction techniques might be possible in order to create covers of this general type, cover panel 20a is cut (slit) from a standard width of aluminum coil. Depending on the gutter size, the actual width of cover panel 20a can be varied by the fabrication tooling that cuts the standard width coil. While aluminum is the preferred choice for its lighter weight and forming or machining capabilities, other materials can be used for the cover of the present invention.

A plurality of C-clips 20b, spaced apart along the length of cover panel 20a, are attached to the outer, upper edge 26 of gutter 21 and are used to capture lip 35. Small sheet metal screws 37 are used to securely attach each C-clip 20b to the gutter 21. The rounded lip 35 of cover panel 20a fits into each C-clip 20b, but the cover panel 20a is not rigidly attached to any of the C-clips. In this way, the cover panel can be pivoted or inclined to the required angle of incline to fit properly in angular alignment with the roof pitch for the particular structure, beneath the lowermost row of shingles. This preferred method of installation positions roof edge 33 of the cover panel 20a beneath the lowermost row of shingles 25a and there is no direct attachment of the cover panel 20a to the structure 22.

The theory behind the use of rounded or curved lip 35 and the positioning of this lip relative to the outer, upper edge 26 of gutter 21 relates to water flow dynamics and the effect of surface tension on the fluid flow dynamics. As rain water flows downwardly across the roof shingles in the direction of gutter 21, this water flows across the upper surface 38 of cover panel 20a. When the rain water reaches rounded lip 35, the theory of this design is that the water will follow the curvature of lip 35, due in part to the surface tension, thereby directing the rain water into the gutter. Any particulate matter or debris, such as leaves and seeds, does not exhibit any similar flow behavior. As a result, this debris does not follow the curvature of lip 35 and instead it cascades off of the cover panel 20a and drops to the ground. The transporting water that has carried the debris to the location of lip 35 follows the curvature of lip 35 and is routed into gutter 21.

There are earlier gutter cover designs that have some type of front lip curvature to take advantage of these flow dynamics. However, there are shortcomings with this type of design if the volume of rain water is significant. With a high flow rate or volume, there can be too much rain water to actually flow as described around a front lip curvature. This “failure” may be due to a combination of the volume of water as well as the flow rate or velocity of the water as it approaches the curved front lip of this type of gutter cover. What has been discovered in the context of the present invention is that in these conditions, the rain water tends to cascade onto the ground along with the debris and does not follow the curvature of the front lip, such as curved lip 35. It appears that the surface tension effect is lost when the volume and/or flow rate of the rain water is significantly higher than that experienced in a light to normal rainfall.

In order to address this problem, the present invention, in the form of cover 20, incorporates a pattern of water siphon slots 42 in cover panel 20a. The intent of having a pattern of slots 42 upstream from lip 35 is to reduce the water volume and flow rate by allowing some of the water to pass downwardly through the siphon slots directly into the gutter 21 upstream from lip 35. Each slot 42 includes a depending lip 43 that is shaped into a generally oblong form. The forming of each lip 43 leaves an oblong opening 44. Each lip 43 includes a free edge 45 and a connecting section 46 that keeps lip 43 joined to the remainder of panel 20a. The lip 43 has an upwardly-facing convex surface 43a and an opposite gutter-facing concave surface. Lip 43 extends below the lower or gutter-facing surface of cover panel 20a. The convex curvature of lip 43 is important as it precludes having a discontinuity or sharp edge at the transitioning location (section 46) with the main body of panel 20a.

As cover panel 20a is slit from the wider coil of aluminum, it is expected that the opposite side edges 33 and 34 will be straight and substantially parallel to each other. Noting that cover panel 20a is an elongated structure such that its longitudinal or length dimension is substantially larger than its width dimension, it will be noted that these opposite side edges are longitudinal. It will also be noted from the drawings that each siphon slot is in oblong form and the length dimension of each oblong opening and the length dimension of each convex lip 43 is substantially parallel to side edges 33 and 34. It will also be noted from the drawings that there are a plurality of siphon slot rows extending lengthwise across cover panel 20a. Each row of siphon slots is substantially parallel to side edges 33 and 34. While the number, size, spacing and shape of each water siphon slot 42 can be changed to some degree and still remain consistent with the focus and teachings of the present invention, it is believed that the illustrated shapes and the siphon slot density, as appearing in the drawings, is preferred. In the preferred embodiment of the present invention, there are four rows of siphon slots 42. A more important design element or aspect of the present invention is the gradual curvature in a convex manner (upwardly facing) for the connecting section 46 and lip 43 of each siphon slot 42. The importance of this specific convex geometry and gradual curvature is described as follows.

As the rain water flows down the roof and begins to flow across the upper surface of cover panel 20a, the water surface tension relative to cover panel 20a and the effect of gravity cause the water to follow the shape of cover panel 20a. Water surface tension is why the water will follow the curvature of lip 35 so as to direct the water around lip 35 and into the gutter. As noted, this is the intended flow path for the water and will likely perform in this manner at normal to moderate levels of rainfall. The concerns and shortcomings of this curved lip design have already been discussed in the context of much heavier rainfall. By shaping each lip 43 of each siphon slot 42 with a convex curvature, this surface tension effect is extended to the design of each siphon slot in order to achieve a similar result with regard to the water flow dynamics. While other cover designs have used a curved front edge or lip for the routing of water and while other designs have used slots, no one has envisioned the novel and unexpected results to be achieved by combining these two features.

If there is a sharp discontinuity in the design of the siphon slots 42 with regard to lip 43, or if there is an opening, break, or sharp edge encountered by the water, it has been learned that the water does not behave in the same fashion relative to the surface tension interaction and the flow of water. These “unacceptable” slot forms, shapes, and contours do not provide a geometry that the flow of water will follow. For example, very little water would actually flow through an oblong opening without the presence of convex lip 43 in the same way that the water would not follow curved lip 35 if instead it was configured as a sharp edge.

By contouring each lip 43 as a leading edge and curved ramp into the corresponding opening 44, the flowing water maintains its surface contact to the lip 43, causing some of the flow of water at that slot location to pass through the slot opening and into the gutter. This then reduces the total volume of water that reaches lip 35, allowing lip 35 to function in its designed and intended fashion, even with high volume amounts of rain water with a high flow rate down the roof and across cover panel 20a. Prior designs with concave lip shapes or inclined lip shapes with sharp edges or covers at their point of juncture to the cover simply do not work to the degree required to lessen or alleviate the high water volume conditions.

It is important to note that the success of the present invention when a front lip 35 is used as part of the cover panel 20a is tied to the addition of siphon slots 42 with their specific geometry as described. From the perspective of ease of use and compatibility with virtually any style of roof and roof pitch, the C-clip 20b becomes the critical element. The C-clip 20b is the only item to be securely attached directly to the gutter 21. These C-clips 20b preclude the need to physically attach the cover panel 20a to any portion of the roof 24 or structure 22.

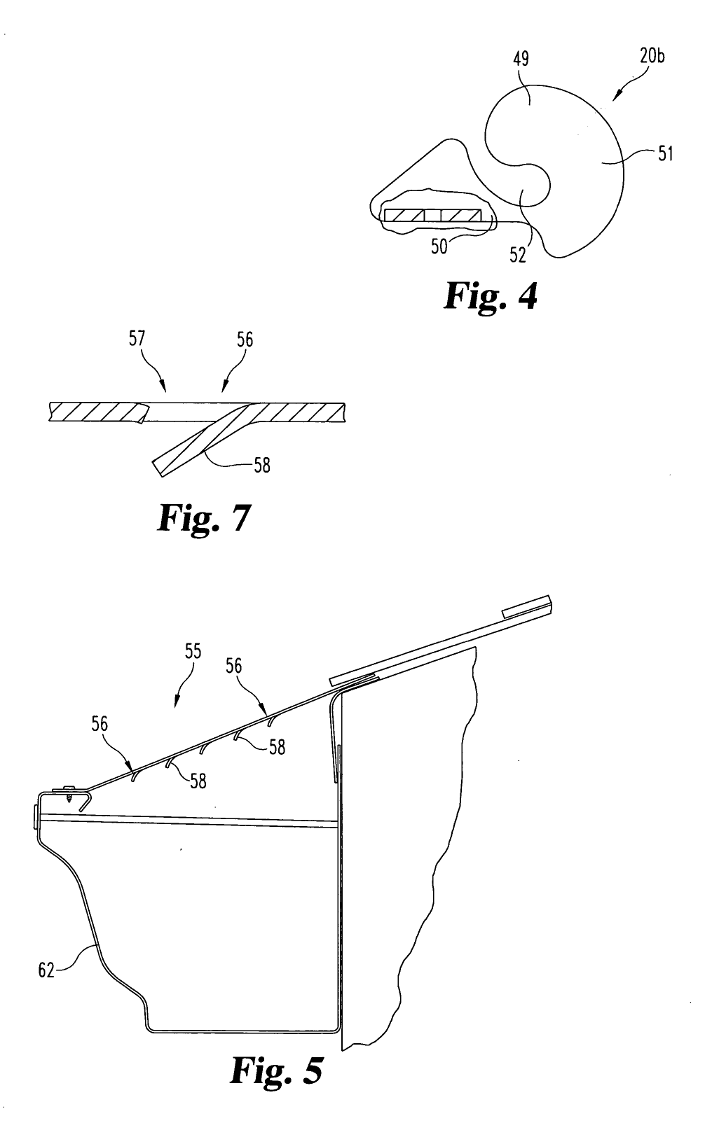

Referring to FIG. 4, the C-clip 20b is illustrated in greater detail. The main body 49 includes a mounting portion 50 and a curved clip portion 51. Portions 50 and 51 are spaced apart to define a curved panel-receiving slot 52. Once the cover panel 20a is assembled beneath the lower row of shingles, the C-clips 20b are fitted onto lip 35 and then attached to the gutter. Even with different roof pitch angles, all that is required is to flex or tilt the flatter portion of cover panel 20a so that it matches the roof pitch so as to install properly. A sheet metal screw is used to attach each C-clip 20b to the outer upper edge 26 of gutter 21.

Since the gutter cover 20 of the present invention is constructed and arranged to attach to an existing gutter, it can be used for new construction once the gutters are installed as well as for existing structures, whether or not the current gutters are being replaced. This intended versatility has been considered in the design of the C-clips 20b and the interfit of the cover panel 20a into the C-clips. This C-clip 20b design and the manner of receipt of panel 20a in slot 52 enables the panel 20a to be positioned anywhere from an approximate horizontal orientation, using the ground as the horizontal reference, to at least a forty-five degree (45°) incline, upwardly toward the roof. The majority of applications will have a ten degree (10°) to twenty-five degree (25°) incline. Importantly, the angle of incline of panel 20a generally corresponds (matches) the angle of incline (pitch) of the roof. It is unlikely to see a roof pitch greater than forty-five degrees, but if that type of roof is encountered, the present invention is still compatible. However, a roof that is too steep can create too much water flow velocity in a downward direction during a heavy rain. If the cover panel 20a is arranged at a correspondingly steep incline, the water velocity causes the water to flow past the siphon slots and, while some water may enter the slots, the rapidly flowing rate, combined with the steep incline, does not behave in the same manner as with an incline closer to or less than forty-five degrees.

Since panel 20a is not nailed to the roof 24 or to the structure 22, there is no risk that any roof leaks will develop and there is no risk of voiding any roof warranty. Additionally, panel 20a is able to float freely in the event it experiences thermal changes. Since the C-clip 20b captures the panel 20a by use of the curved slot 52 but does not clamp or restrict it, panel 20a is able to expand and contract and does not experience any buckling. The capturing of panel 20a by each C-clip 20b secures the panel 20a from coming out of its captured condition by moving up or down or by moving in or out.

While the preferred embodiment of the present invention has been described in the context of gutter cover 20 and FIGS. 1-4, at least one alternate embodiment is envisioned that could have value in specific situations.

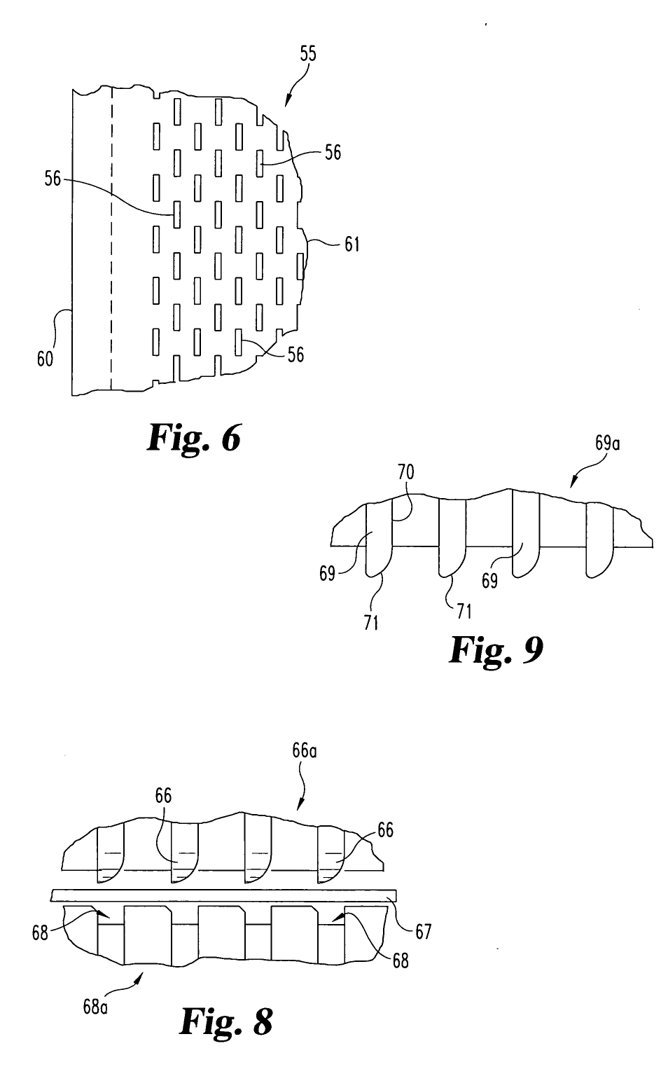

With reference to FIGS. 5-7, it will be seen that gutter cover 55 is configured as a unitary panel without the use of any C-clip or similar accessory. The changes to cover 55, as contrasted to panel 20a, include elimination of any curved lip 35 and the creation of larger (i.e., longer) siphon slots 56 and a greater number of siphon slots per unit area of the panel material. There are now eight rows and the overlapping stagger is closer.

As with cover panel 20a, each siphon slot 56 includes a generally rectangular or oblong opening 57 that is created by the forming of the convex, depending lip 58. The connecting section 59 keeps lip 58 connected to the remainder of cover 55 and it is lip 58 that has the convex (upwardly-facing) shape to take advantage of the surface tension of the flowing rainwater.

There is an increased siphon slot 56 density on cover 55 compared to cover panel 20a. This increased density is achieved by putting the rows of slots 56 closer together between front edge 60 and roof edge 61. When this increased slot density is combined with the increased length of each slot (i.e., a larger opening), it will be understood that the open area percentage of cover 55, relative to a unit area, is increased over the percentage of open area with panel 20a. By significantly increasing the open area on a per-unit area basis with regard to the cover or panel, the expectation is that a majority of the rain water will flow into the slots 56 and from there directly into the gutter 62.

With regard to the fabrication of panel 20a, it is known to begin with a coil or length of aluminum material that is run through a slitter with a cutting knife or knives to make length-wise cuts in the aluminum. Optional knife designs are offered for perforating the material for ventilation purposes and for forming strengthening ribs. One such slitter, as described above, is a PORT-O-SLITTER® tool offer by Tapco Products Company, Inc. of Detroit, Mich.

Since conventional perforations, as would be produced by the available knives for the described slitter tool, would not be acceptable for the present invention, design changes were required. The need was to create an opening and a cooperating convex lip 43 so as to take advantage of the surface tension effect to siphon off some of the rain water and route it into the gutter 21 upstream of the curved front lip 35, as has been described and discussed.

The described “knives” for the slitter tool are actually raised projections 66 on a ring-like male roller 66a (see FIG. 8). The male roller 66a is positioned adjacent one side of the aluminum panel 67 and a corresponding female roller 68a is positioned on the opposite side of the aluminum panel 67. The female roller 68a includes recesses 68. The male roller 66a includes four rows of projections 66 and the female roller 68a includes four rows of recesses 68. As would be understood from this type of tooling, the raised projections 66 cooperate with recesses 68 so as to perforate the aluminum panel. The four rows of projections and the four rows of recesses also correspond to the four rows of siphon slots 42 as described in the context of cover panel 20a.

A first shaft adjacent the upper surface of aluminum panel 67 carries the male roller 66a and a second parallel shaft positioned on the gutter-facing surface of aluminum panel 67 carries the female roller 68a, in alignment with the male roller 66a, as diagrammatically illustrated in FIG. 8.

The modifications for the present invention were directed to the projections 66 of male roller 66a. As is illustrated in FIG. 9, the side edge shape of each projection 66 is changed into a tapered, curved shape for each projection 69 of the present invention. While the illustrated curvature looks as if it is only a narrow tip, the curvature is along a long side of each projection. This curved side shape for each projection 69 still cooperates with the aligned female recesses 68 and, as a result, the siphon slots 42 as described herein are created. The straight side 70 of each projection 69 actually punctures the aluminum panel for the slot opening 44 while the curved side 71 shapes the lip 43 with an upwardly facing, convex curvature, as described herein. The width of each projection sets the width of the opening of each siphon slot 42.

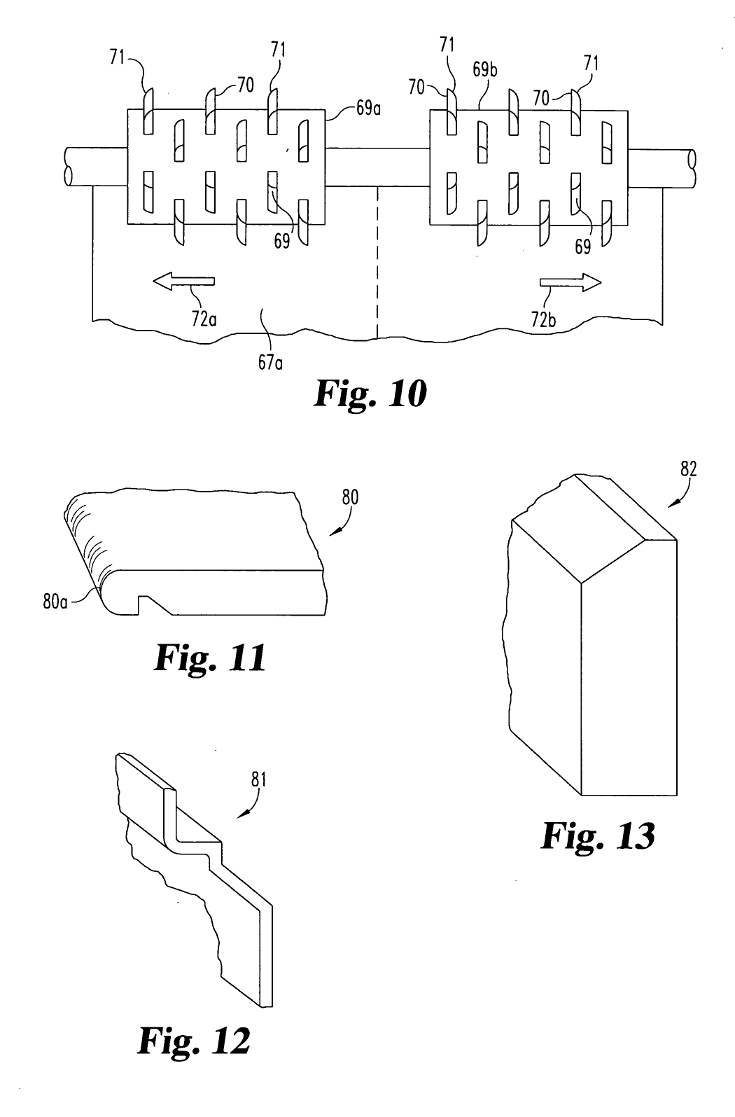

Each projection 69 has an arc length around the circumference of roller 69a (see FIG. 10). This arc length corresponds to the length of each siphon slot 42. There is a circumferential spacing between adjacent projections 69. This relative arc length and spacing determines the side-to-side overlap of siphon slots in adjacent rows as well as determining part of the slot density in the panel. The side-to-side spacing between the four rows of projections sets the row-to-row spacing of the siphon slots 42 in the finished cover 20a. As noted, this particular spacing also contributes to setting or determining the siphon slot density, per unit area, in cover 20a.

When the perforating operation was performed on a single-wide length of aluminum, (one gutter cover panel) to create the described siphon slots 42, it was learned that the curvature of side 71 of each projection 69 created a force vector that tended to pull the aluminum to the side to the point of actually stretching the aluminum or distorting it in a manner that would be unacceptable for a gutter cover panel. In order to address this problem, it was conceived as part of the present invention to arrange one male roller 69a on one side of a double-wide aluminum panel 67a and a corresponding and cooperating male roller 69b on the opposite side of the panel, as is illustrated in FIG. 10. By positioning the curved side 71 of each projection 69 in an outward direction (see arrows 72a and 72b), the force vectors, due to the curvature of side 71, act in opposite directions on the two panels of material. With the two pairs of rollers 69a and 69bpulling in the opposite direction, the pulling forces are equal, opposite, and neutralized, allowing the two strips or panels of perforated material to remain straight and not distorted. At this point in the fabrication sequence, two perforated aluminum panel strips of cover material with the desired siphon slots 42 are created, but each one still requires the forming or shaping of the material adjacent the gutter-facing edge in order to created curved lip 35.

In order to create the larger radius for lip 35, a portable sheet metal brake (not illustrated) is used with suitable tooling attachments that are constructed and arranged to create the curvature for lip 35. The first tooling attachment 80 (see FIG. 11) is a length of aluminum having the desired radius along edge 80a. This attachment 80 is assembled to the top of the sheet metal brake. The second tooling attachment 81 (see FIG. 12) is a multi-section or multi-panel structure that attaches to the lower portion of the brake, and it is this lower portion of the break that is able to be pivoted upwardly towards the upper portion of the brake. With the brake assembled with the first and second tooling attachments, a length of aluminum cover material, perforated with the desired pattern of siphon slots 42, is positioned in the brake. The next step is to rotate the lower portion of the brake and moving or pivoting the second tooling attachment 81 to partially form the larger radiused lip 35 for that cover 20a.

The third tooling attachment 82 (see FIG. 13) is basically a shim that is positioned between the second tooling attachment 81 and the first formed lip 83 for creating radiused lip 35. Next, when the lower portion of the brake is rotated again for the final forming of lip 35, the third tooling attachment pushes lip 83 around edge 80a, achieving the desired curvature for lip 35.

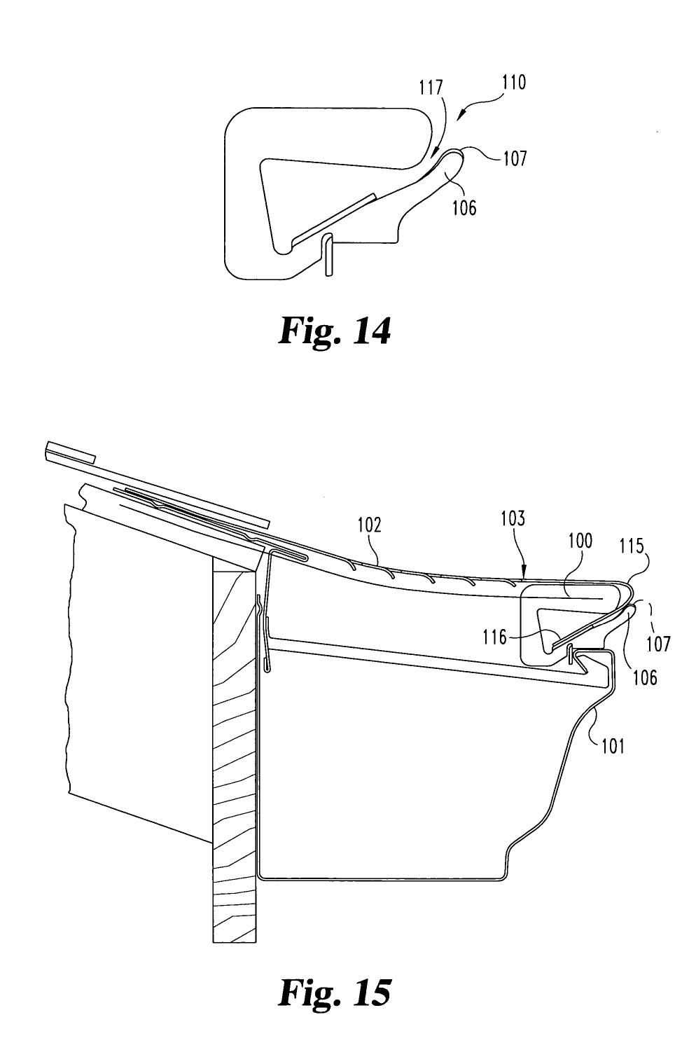

Referring to FIGS. 14-17, there is illustrated a “nose-over” clip 100 constructed and arranged according to an alternative embodiment of the present invention. A side elevational view of clip 100 is provided by FIG. 14. In FIG. 15, this same orientation for clip 100 is provided, except now the clip is illustrated in an as-assembled condition on a gutter 101 connecting with a gutter cover panel 102. Gutter cover 103 denotes the assembled combination of panel 102 and one or more clips 100, depending on the gutter section and the length of panel 102. Panel 102 is intended to have a construction and arrangement virtually identical to panel 20a, including the same style and patterns of siphon slots 42.

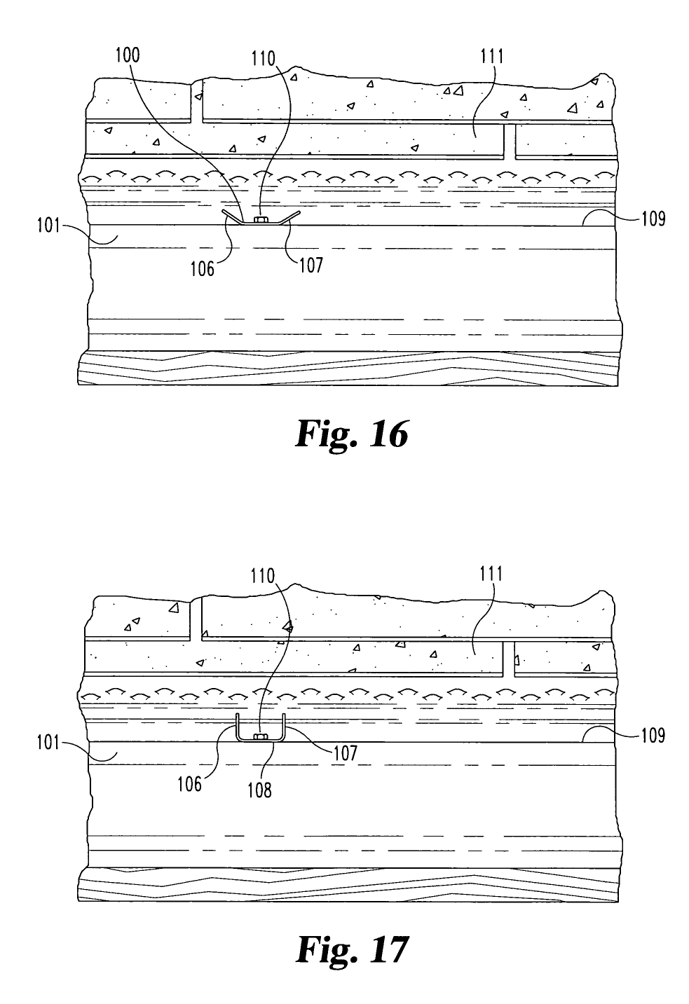

The initial installation of each clip 100 is performed with each of the opposed tabs 106 and 107 bent down (see FIG. 16) so as not to interfere with the installation of panel 102. The center portion 108 of clip 100 attaches directly to the top surface 109 of gutter 101 with a threaded fastener 110. As illustrated, with the tabs 106 and 107 bent over (i.e., bent down), the panel 102 is able to be installed under the shingle 111 and into the receiving slot or channel 112 of clip 100, without any interference with tabs 106 and 107. The forward-facing edge 115 of panel 102 is rounded for routing water into the gutter, as previously described herein. The free edge 116 of panel 102 inserts into the narrow entry 117 of slot or channel 112 (see FIGS. 14 and 15).

With the panel 102 properly installed beneath the lower row of shingles and into each cooperating clip 100, the tabs 106 and 107 of each clip are bent up in order to secure the panel 102 in position (see FIG. 17). While the metal selected for clips 100 and the metal thickness enable the manual bending of the tabs, the clips 100 remain securely attached to the gutter and are strong enough to retain the panel 102 in its desired position beneath the lowest row of shingles and within the clip slot or channel.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A cover panel for a roof gutter comprising:
an elongated main body having an upper surface and an opposite gutter-facing surface and being bounded by a longitudinal roof-side edge and opposite thereto a longitudinal gutter-side edge, said main body defining a plurality of water siphon slots that are positioned between said roof-side edge and said gutter-side edge, each water siphon slot of said plurality including an opening extending through said main body and a depending lip formed to extend below said gutter-facing surface, said depending lip having a curved upper surface.

2. The cover panel of claim 1 wherein each siphon slot has an oblong shape with a length extending substantially parallel to said gutter-side edge.

3. The cover panel of claim 2 wherein said plurality of siphon slots are arranged into a plurality of uniformly-spaced rows, each row extending substantially parallel to said gutter-side edge.

4. The cover panel of claim 3 wherein said main body includes a curved lip that is adjacent said gutter-side edge.

5. The cover panel of claim 1 wherein said plurality of siphon slots are arranged into a plurality of uniformly-spaced rows, each row extending substantially parallel to said gutter-side edge.

6. The cover panel of claim 1 wherein said main body includes a curved lip that is adjacent said gutter-side edge.

7. In combination for creating a cover for a roof gutter:
a cover panel having an elongated main body having an upper surface and an opposite gutter-facing surface and being bounded by a longitudinal roof-side edge and opposite thereto a longitudinal gutter-side edge, said main body defining a plurality of water siphon slots that are positioned between said roof-side edge and said gutter-side edge, each water siphon slot of said plurality including an opening extending through said main body and a depending lip formed to extend below said gutter-facing surface, said depending lip having a curved upper surface; and
at least one securing clip constructed and arranged to be attached to a portion of said roof gutter, said securing clip having a defined curved slot for receipt of said gutter-side edge.

8. The combination of claim 7 wherein each siphon slot has an oblong shape with a length extending substantially parallel to said gutter-side edge.

9. The combination of claim 8 wherein said plurality of siphon slots are arranged into a plurality of uniformly-spaced rows, each row extending substantially parallel to said gutter-side edge.

10. The combination of claim 9 wherein said main body includes a curved lip that is adjacent said gutter-side edge.

11. The combination of claim 7 wherein said plurality of siphon slots are arranged into a plurality of uniformly-spaced rows, each row extending substantially parallel to said gutter-side edge.

12. The combination of claim 7 wherein said main body includes a curved lip that is adjacent said gutter-side edge.

13. The combination of claim 7 wherein said at least one securing clip includes a pair of tabs constructed and arranged for holding said unitary cover panel in position when in a first position and for enabling removal of said gutter cover panel when in a second position.

14. The combination of claim 13 wherein the pair of tabs of said at least one securing clip being constructed and arranged to be manually bendable between said first position and said second position.

15. A fabrication tool for creating siphon slots in a gutter cover panel, said gutter cover panel having an upper surface and an opposite gutter-facing surface, said fabrication tool comprising:
a female roller with defined recesses therein mounted on a shaft and positioned adjacent said gutter-facing surface; and
a male roller with projections thereon that are constructed and arranged to be aligned with said defined recesses, each projection having a flat side and an opposite curved side, said male roller mounted on a shaft and positioned adjacent said upper surface, wherein said projections puncture said gutter cover panel to create said siphon slots, said curved side forming a depending lip having a convex upper surface.
